(19) United States
(12) Patent Application Publication
(10) Pub. No.: US 2002/0047222 A1
(43) Pub. Date: Apr. 25, 2002

(54) Mold for forming a dental prosthetics

(76) Inventor: Graham K. Philp JR., Palm Harbor, FL (US)

Correspondence Address: SHLESINGER, ARKWRIGHT & GARVEY LLP, 3000 South Eads Street, Arlington, VA, 22202, US

(21) Appl. No.: 09/977,330

(22) Filed: Oct. 16, 2001

Related U.S. Application Data
(60) Provisional application No. 60/240,088, filed on Oct. 16, 2000.

(51) Int. Cl. A61C 13/20; B29C 33/40

(52) U.S. Cl. 264/16; 264/227; 425/130; 425/DIG. 11

(57) ABSTRACT

A method of making a new dental prosthetic from an existing dental prosthetic including the steps of providing an existing dental prosthetic; and providing a mold having a bottom half and a top half, the bottom half including a side wall, a closed bottom and an open top face for mating with the top half, the top half including a further side wall, an open bottom face for mating with the open top face of the bottom half, and a partially opened top. The bottom half is then partially filled with a first molding material, and a first portion of the existing denture of a first molded material. The top half of the mold is placed on the bottom half of the mold; and a portion of the first material and a further portion of the existing denture is covered with a second material. A mold for making a dental prosthetic includes a top half and a mating bottom half. The bottom half includes a side, an open top, and a substantially closed bottom. The top half includes a side, an open bottom which mates with the top of the bottom half, and a partially opened top. A locking element may be provided for permanently or detachably attaching the top and bottom halves of the mold, such as for shipping.

### CROSS REFERENCE TO RELATED APPLICATIONS

This application claims priority benefit of application No. 60/240,088, filed Oct. 16, 2000, which is incorporated herein by reference.

### FIELD OF THE INVENTION

The invention relates to molds. More specifically, the invention relates to molds for forming dental prosthetics. Even more specifically, the invention relates to molds for forming dental prosthetics that include top and bottom halves, and can be used to ship the molded material used in the process of using dental prosthetics to an off-site laboratory. The invention likewise relates to a method of making a new dental prosthetic from an existing dental prosthetic.

### BACKGROUND OF THE INVENTION

Molds have been available for years. Prior art molds in the dental field have been unsatisfactory owing to their cost, difficulty in using, and hygiene concerns, for example.

### OBJECTS AND SUMMARY OF THE INVENTION

Accordingly, it is an object of the invention to provide a method and a mold usable in such method, which overcome the drawbacks of the prior art.

Another object is to provide a mold which is easier to use, more cost effective, more hygienic, and can be used in a method carried out in part or completely in the practitioner's office.

A further object is to provide a mold which can be used as a shipping container, for the case in which the practitioner wants to ship negatives, for example, of new dental prosthetics to be formed to an off-site laboratory.

The invention solves the above-described drawbacks and achieves the above-described objects.

The invention includes the method of making a new dental prosthetic from an existing dental prosthetic. The method includes the steps of

a) providing an existing dental prosthetic;

b) providing a mold having a bottom half and a top half, the bottom half including a side wall, a closed bottom and an open top face for mating with the top half, the top half including a further side wall, an open bottom face for mating with the open top face of the bottom half, and a partially opened top;

c) partially filling the bottom half with a first molding material;

d) placing a first portion of the existing denture in a first molded material disposed on the bottom half;

e) placing the top half of the mold on the bottom half of the mold; and

f) providing a second material and covering a portion of the first material and a portion of the existing denture with a second material.

The invention also includes a mold for making a dental prosthetic, including a top half and a mating bottom half. The bottom half include a side, an open top, and a substantially closed bottom. The top half includes a side, an open bottom which mates with the top of the bottom half, and a partially opened top.

Relative terms, such as top, bottom, left, and right are for convenience only and are not intended to be limiting. The term “locked together” includes detachably attached locking, permanent locking, the ability to both detachably attach and permanently lock, and by use of a single mechanism or combination of elements, and which may serve the function of seating. That is, seating in the sense of aligning two (2) elements relative to each other.

The term denture may be read as including all types of dental prosthetics, as appropriate.

### BRIEF DESCRIPTION OF THE DRAWINGS

FIG. 1 is a top plan view of a first preferred embodiment of a bottom half of a mold according to the invention;

FIG. 2 is a right side view of the embodiment of FIG. 1;

FIG. 3 is a top plan view of a first preferred embodiment of a top half of a mold according to the invention;

FIG. 4 is a right side view of the embodiment of FIG. 1;

FIG. 5 is a top perspective view of a further preferred embodiment of a mold according to the invention;

FIG. 6 is a top perspective view of a still further preferred embodiment of a mold according to the invention; and

FIG. 7 is an enlarged view of a portion of the locking element of FIG. 6.

### DETAILED DESCRIPTION OF THE INVENTION

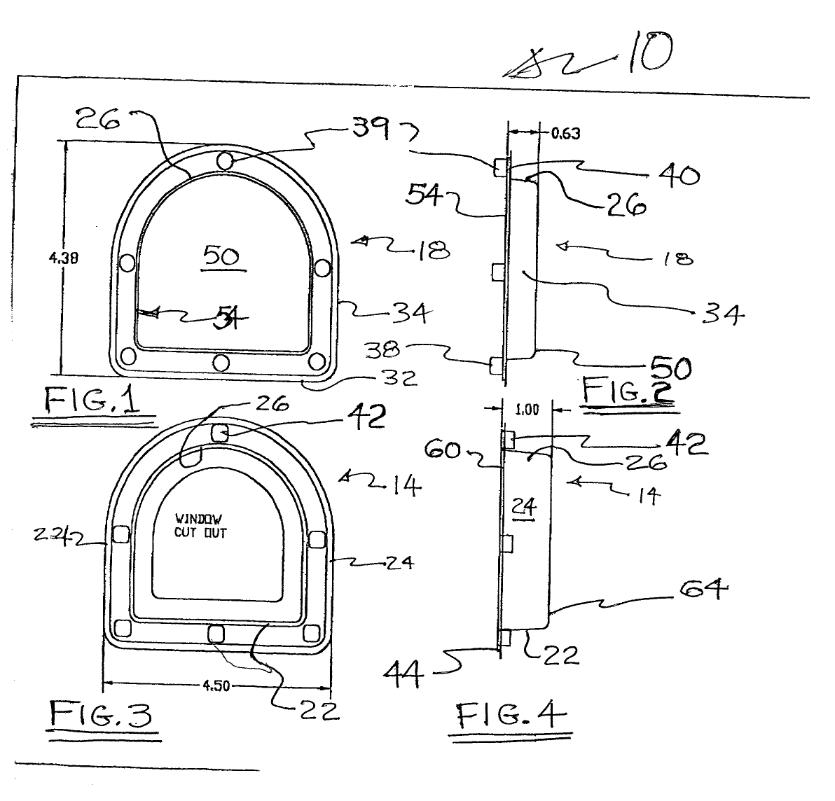

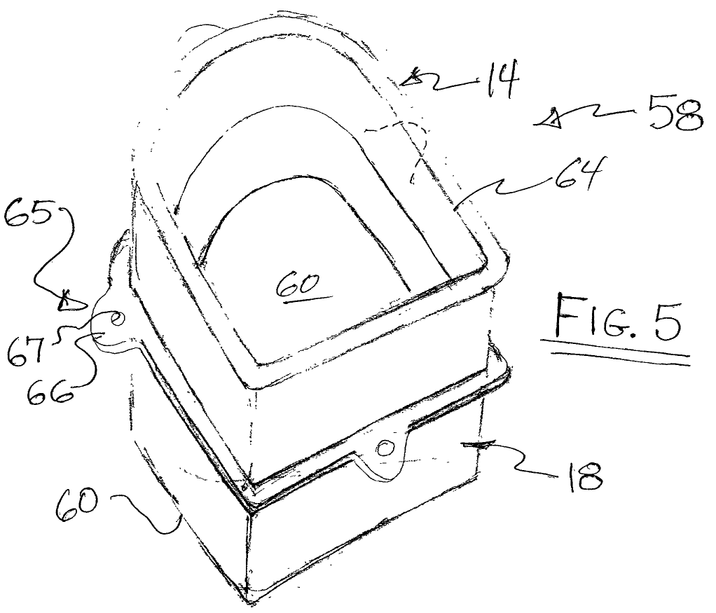

FIGS. 1-4 show a mold or tray 10 according to a first preferred embodiment of the invention. Mold 10 includes a top half 14 and a bottom half 18. At least one side defines the interior of top half 14. Two (2) or more sides 22 and 24 may be provided. A curved or contoured side 26 may be provided. Curved side 26 may serve to make apparent the orientation of halves 14 and 18 for readily joining together halves 14 and 18, in use.

In the case where a dental prosthetic to be copied is placed in mold 10, and the prosthetic is a denture, the forwardmost portion, (i.e., with the front teeth) of the denture may be located near side 26.

Such curving of side 26 reduces the material required to make mold 10, and reduces the amount of material required to be placed in mold 10, in use, when copying a denture.

Bottom half 18 may have a similar curved side 26, and an opposed side 32.

An extension 39 may be provided on a lip 40 of bottom half 18. Mating, corresponding recesses 42 on a lip 44 of top half 14 may likewise be provided. The mating of extensions 39 and recesses 42, in use, restricts relative movement between the mold halves 14 and 18. Extensions 39 and recesses 42 may be sized and configured so as to lock top 14 to bottom 18. The locking may be reversible or permanent.

In the case of permanent locking, the user may separate the two (2) halves 14 and 18 by removing at least some of the elements 39 and 42, such as by cutting off portions of lips 40 and 44, after the halves have been joined, in use.

Please note that it is expected that, typically, in initial stages of methods of making new dental prosthetics by copying existing prosthetics, even permanently detachable locking elements will not be permanently attached during at least initial steps of copying the dentures. The locking will typically be for shipping of the dental prosthetics. Thus, it is expected that elements 39 and 42 may be attached at a first depth, for example, which restricts relative movement of the two (2) halves 14 and 18 of the mold, and prevents undesired leakage of the molding material during one or more steps of the method, while elements 39 may be extended further into elements 42 to a second depth at which elements 39 and 42 are permanently locked together. The second depth will typically be deeper than the first depth.

A bottom 50 of tray 18 may be substantially or completely closed (as shown).

A top 54 of bottom half 18 may be substantially or completely open.

A bottom 60 of top half 14 may be substantially completely open. The open region of bottom 60 may correspond to the open region of top 54 of bottom half 18.

A top 64 of top half 14 may be substantially or completely open.

In use top 54 of bottom half 18 mates with bottom 60 of top half 14.

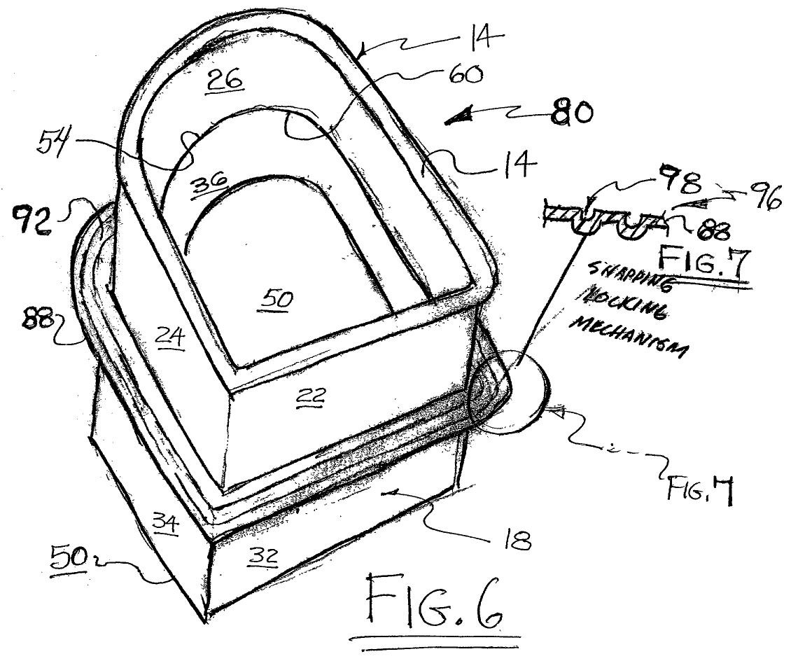

FIG. 5 illustrates another preferred embodiment of a mold 58 according to the invention.

Mold 58 may have a locking element 65 including an extension 66 formed on typically both top 14 and bottom 18. A hole 67 may extend through one or both of top and bottom extension 66.

A fastener, such as an unillustrated nut and bolt or wing nut and bolt may be used to secure top 14 to bottom 18.

A piece of metal, such as brass, may extend around the perimeter of the mating mold halves and may include extension 66.

A seal, such as a rubber gasket, may be placed between the mating halves 14 and 18, in use.

The rubber gasket will be used when a first material, such as an alginate, is used in the process of making a new denture from an existing denture, and the alginate is shipped with mold 58 to an off-site laboratory for a part of the processing.

FIGS. 6 and 7 show another preferred embodiment of a mold 80 according to the invention.

Mold 80 includes a lip 88 on bottom half 18, and a lip 92 on top half 14.

Lip 88 may include an alignment and/or locking element 96 which may comprise one or more recesses or groves 98. Groves 98 may be configured to detachably or non-detachably mate with corresponding protrusions or elongated extensions on lip 92 of top half 14.

The container may be made of a rigid material. The material may be selected for one-time use; i.e., for being disposable. Various plastics are suitable which yield sufficiently rigid sides of the top and bottom halves, yet which can be used in relatively small amounts to reduce costs, such as by having thin walls.

An envelope may be provided to cover the cast alginate, in use, (see application Ser. No. 09/256,455 to Diasti et al., filed Feb. 23, 1999 which is incorporated herein by reference) prior to shipment to an off-site lab. That would be typically for the case where alignate negative is shipped off-site for further processing. The envelope would prevent drying out and shrinkage of the cast alginate negative.

A known liquid is available that likewise can be provided for preventing shrinking of the cast alginate for 4-6 weeks.

A break away line can be provided on one or both halves of the mold. For example, a vertical fault line allowing ready separation of two (2) or more parts of a side of one or both halves of the mold may be provided.

The locking mechanism typically is engineered to lock only for shipping, not for during the initial steps of a molding process. By referring to application Ser. No. 09/256,455 to Diasti et al., one will note that the mold halves must be taken apart and put back together during the initial steps of the process of making new dental prosthetics from old ones.

Good results have been achieved when a alginate or hydrocolloiod has been used instead of or in conjunction with the locking elements or seals according to the invention. An alginate that retains its hardened, cast negative of the dental prosthetic over time may be used instead of a seal to retain moister in the mold, such as for shipping, or for storage while awaiting further processing into the completed dental prosthetic. An example of an alginate that can be used with the mold according to the invention instead of the seals, gaskets, locking mechanism, and the like is KROMOPAN 100 (Lascod S.p.A. of Florence, Italy). That KROMOPAN brand 100 hydrocolloid is engineered to stay stable for as long as 100 hours after being used to make a negative of a dental prosthetic. Thus, the entire mold with hydrocolloid therein may be shipped to an off-site lab. Many known alginates tend to dry out when in their cast form as negatives of dental prosthetics, for example, and shrink as they dry out. Such shrinkage is unacceptable, as it leads to distortion of the negative (i.e., the mold) of the cast dental prosthetic. The distortions are unacceptable because a correct copy can not be made, of course.

It will thus be appreciated, that the seals, gaskets, and locking mechanisms according to the invention may still be used, so that the user need not make alginate negatives of the dental prosthetic to be replicated in the inventive mold and, hence, be required to use a specific alginate, such as KROMOPAN 100, which is stable for up to 100 hours.

Separate clips may be used to provide a locking function for shipment. The clip may be used instead of or in addition to the above-described locking elements.

The locks may be hook-like elements provided on one half and configured for mating with corresponding holes on the mating half of the mold.

The outwardly extending lips or flanges to which the locking element(s) are attached may be thicker/stronger than the side wall(s) of the mold halves.

While this invention has been described as having a preferred design, it is understood that it is capable of further modifications, and uses and/or adaptations of the invention and following in general the principle of the invention and including such departures from the present disclosure as come within the known or customary practice in the art to which the invention pertains, and as may be applied to the central features hereinbefore set forth, and fall within the scope of the invention or limits of the claims appended hereto.

1. A method of making a new dental prosthetic from an existing dental prosthetic, comprising the steps of:
a) providing an existing dental prosthetic;
b) providing a mold having a bottom half and a top half, the bottom half including a side wall, a closed bottom and an open top face for mating with the top half, the top half including a further side wall, a partially open bottom face for mating with the open top face of the bottom half, and a partially opened top;
c) partially filling the bottom half of the mold with a first molding material;
d) placing a first portion of the existing denture in the first molded material disposed in the bottom half;
e) placing the top half of the mold on the bottom half of the mold; and
f) providing a second material; and
g) covering a portion of the first material and a further portion of the existing denture with the second material.

2. A method as in claim 1, wherein:
a) the step of providing the second material includes adding the second material through the partially open bottom face of the top half.

3. A method as in claim 1, wherein:
a) the first material includes an alignate.

4. A method as in claim 1, wherein:
a) the second material includes a dental stone.

5. A method as in claim 1, wherein:
a) the first portion of the existing dental prosthetic includes a tooth.

6. A method as in claim 1, wherein:
a) the second portion of the existing dental prosthetic includes a portion of a jaw side of a dental prosthetic.

7. A method as in claim 1, wherein:
a) a locking device is provided for attaching the top half of the mold to the bottom half.

8. A method as in claim 7, wherein:
a) a locking device detachably attaches the top half to the bottom half.

9. A method as in claim 7, wherein:
a) the locking device permanently attaches the top half to the bottom half.

10. A method as in claim 1, further comprising the steps of:
a) allowing the first and second material to harden;
b) removing the dental prosthetic from the first and second material;
c) using the hardened first and second materials to form a negative of the existing dental prosthetic; and
d) using the negative of the existing dental prosthetic to make a positive of a new dental prosthetic.

11. A method as in claim 10, further comprising the step of:
a) making corrections to the existing dental prosthetic prior to making the negative.

12. A mold for making a dental prosthetic, comprising:
a) a top half and a mating bottom half;
b) said bottom half including a side, an open top, and a substantially closed bottom; and
c) said top half including a side, an open bottom which mates with said top of said bottom half, and a partially open top.

13. A mold as defined in claim 12, wherein:
a) said top of said top half includes a substantially completely opened top face.

14. A mold as defined in claim 13, wherein:
a) a locking element is provided, and said locking element locks said top half to said bottom half.

15. A mold as defined in claim 14, wherein:
a) said locking element includes a lip provided on said bottom half of said mold, and said lip engages and locks said top half to said bottom half.

16. A mold as defined in claim 15, wherein:
a) said locking element detachably attaches said top half to said bottom half.

17. A mold as defined in claim 15, wherein:
a) said locking element permanently attaches said top half to said bottom half.

18. A mold as defined in claim 15, wherein:
a) said locking element includes a further lip provided on said top half of said mold.

19. A mold as defined in claim 15, wherein:
a) said locking element includes a fastener.

20. A mold as defined in claim 12, wherein:
a) an alignment element is provided for aligning said top half and said bottom half when mated together.

21. A mold as defined in claim 20, wherein:
a) said alignment element includes an extension on said bottom half of said mold and a corresponding recess on said top half of said mold.
